(19) United States
(12) Patent Application Publication
(10) Pub. No.: US 2026/0196933 A1
(43) Pub. Date: Jul. 9, 2026

(54) CONTINUOUS-TIME COMPARATOR FOR PRESELECTOR MANAGEMENT IN BOOST CONVERTER

(71) Applicant: STMicroelectronics International N.V., Geneva (CH)

(72) Inventors: Stefano RAMORINI, Milano (IT); Francesco PINZIN, Varese (IT)

(73) Assignee: STMicroelectronics International N.V., Geneva (CH)

(21) Appl. No.: 19/012,211

(22) Filed: Jan. 7, 2025

(51) Int. Cl. H02M 3/158; H02M 1/00

(52) U.S. Cl. CPC H02M 3/158; H02M 1/0032

(57) ABSTRACT

A DC-DC power converter includes a continuous-time comparator that monitors an input voltage and an output voltage to automatically control a preselector core. The comparator generates bias conditions based on the actual voltage differential between the input voltage and the output voltage, eliminating the need for discrete logic control. When the input voltage exceeds the output voltage, the circuit configures itself to enable charging of the output voltage through a controlled current path. When the output voltage exceeds the input voltage, the circuit reconfigures to enable current recirculation through the preselector core. The continuous-time comparison eliminates static current consumption during reset phases and provides immediate response to voltage differentials without complex timing or control logic. This architecture results in a simple, efficient voltage converter well suited for applications desiring minimal control overhead and responsive voltage regulation.

### TECHNICAL FIELD

This disclosure relates to the field of power electronics. More specifically, it relates to a continuous-time comparator for preselector management in a boost converter.

### BACKGROUND

Boost converters are a type of DC-DC power converter that steps up an input voltage to a higher output voltage. In boost converter topologies, a component known as a preselector may be utilized. The preselector circuit plays a crucial role in managing voltage differences and ensuring safe operation, particularly when the input voltage exceeds the output voltage. The main role of the preselector is to connect the body of the power high-side (MPHS in FIG. 1) to the higher of the voltage between VIN and VO3.

Referring now to FIG. 1, a DC-DC power converter 5 includes a preselector management circuit 30, preselector core 50, power high-side and logic circuit 60, and power stage 70

The power high-side and logic circuit 60 includes an inverter 71 powered between a preselection voltage VP and a clamp voltage PCLAMP (PCLAMP being a floating rail which its positive counterpart supply is the voltage preselector VP), the inverter 71 receiving a high-side command HSCMD signal at its input.

The preselector core 50 includes node Nn1 connected to a second terminal of an inductor L with the first inductor L being coupled to receive an input voltage VIN. A p-channel transistor MA has its drain connected to VIN, its source connected to node Nn2, and its gate connected to node Nn3. A p-channel transistor MB has its source connected to node Nn2 (with a preselection voltage VP being formed at node Nn2), its drain connected to node Nn3, and its gate coupled to receive the gate control GATEMB signal. A p-channel transistor MPHS has its drain connected to node Nn1, its source connected to node Nn3, and its gate connected to the output of inverter 71.

An output capacitor C is connected between node Nn3 and ground, with an output voltage VO3 being formed across capacitor C.

The low-side power stage 70 is connected between node Nn1 and ground.

The preselector management circuit 30 includes a resistor R1 connected between nodes Nn2 and Nn3, and a Zener diode Z1 having its anode connected to node Nn3 and its cathode connected to node Nn2. The Zener diode Z1 serves to limit the voltage difference between the voltage VP at node Nn3. The gate control GATEMB signal is generated at node Nn3. An n-channel transistor TR1 has its drain connected to node Nn3 and its gate coupled to the input voltage VIN. An n-channel transistor TR2 has its drain connected to the source of n-channel transistor TR1, its source coupled to current source 31 acting as a current sink, and its gate connected to a digital logic to receive the enable signal ENMB. The current source 31 drives the gate of transistor MB, turning it on when the signal ENMB is high, influencing the regulation of the voltage VP when TR2 is turned because in this condition VP is shorted to Nn3.

Referring additionally to FIG. 2, when the input voltage VIN is greater than the output voltage VO3, the circuit operates to safely equalize these voltages which without causing excessive inrush current or creating uncontrolled conductive paths. Initially, when the voltage VIN is turned on at time T1, if the difference between VIN and VO3 is higher than the activation threshold of MA, MA shorts the voltage VP at the same voltage of VIN, biasing the body of MPHS. Otherwise, the preselector voltage is biased to one diode threshold below VIN. This configuration avoids an uncontrolled conductive path existing from the input voltage VIN to the voltage VO3 across capacitor C. When the soft-start begins at time T2, the control signal HSCMD transitions to a high state, turning on transistor MPHS, and current begins to flow from the input voltage VIN, through inductor L, through transistor MPHS, into capacitor C – this current path is shown in FIG. 1A. This allows the voltage VO3 to charge gradually towards the input voltage VIN, as shown by the rising edge of voltage VO3 between T2 and T4. The inherent drain-source resistance of transistor MPHS acts as a current limiter, mitigating the risk of inrush currents that could potentially harm components or disrupt normal operation. This controlled charging ensures that the voltage VO3 rises smoothly without causing voltage overshoots or excessive current draw.

During this period, as VO3 approaches VIN – particularly around the crossover point at time T4 – the preselection voltage VP becomes regulated primarily by diode action rather than active transistor control because the voltage gate of MA is close to VIN. When the voltage VO3 has concluded its precharge phase, the signal ENMB is toggled high at time T5. Thanks to current source 31, the drain voltage of transistor TR2 is pulled down, allowing the voltage VP to be shorted to the voltage VO3 through transistor MB. After signal ENMB is asserted, the voltage VO3 start-up can proceed. The PCLAMP voltage, being lower than the voltage VP, serves as the negative rail for the driving stage of the power high-side transistors, ensuring that the gate-source voltage of MPHS remains within safe operating limits throughout the operation. With the voltage VP shorted to the voltage VO3, the drain-body diode of transistor MPHS acts as a recirculation diode, utilizing transistor MB for the current path to the output – this current path is shown in FIG. 1B.

Throughout this operation, the circuit effectively manages the bias of the body of the power transistor MPHS, controlling the charging path and limiting current flow. As the rising voltage VO3 approaches the input voltage VIN, the voltage VP is managed primarily by diode action. These coordinated actions of transistors MA, MB, and MPHS, along with the control signals HSCMD and ENMB, facilitate a safe and efficient transition of the voltage VO3 to match the input voltage VIN, thereby safeguarding the components and ensuring reliable performance when the voltage VIN exceeds voltage VO3, as demonstrated in the voltages depicted in FIG. 2.

The DC-DC power converter 5 utilizes power stage 70 that is responsible for the actual voltage conversion process, stepping up the input voltage VIN to the desired output voltage (VO3) by controlling the energy flow through inductor L in response to control signals generated within the power high-side and logic circuit 60.

The output voltage VO3 at node Nn3, formed across capacitor C connected between node Nn3 and ground, serves as an internal supply voltage and biases specific transistors within the preselector core 50. The voltage VO3 provides the necessary voltage level for generating the gate control signal GATEMB at node Nn3, which controls the gate of p-channel transistor MB. By supplying this internal voltage, VO3, when it is close to ground, allows to bias the body of MPHS can be biased to turn on MA. When VO3 has been precharged to VIN, that is supposed to be higher than the activation threshold of MB, the ENMB toggling allows to turn-on MB and it shorts the net Nn2(VP) to Nn3. In this way MA and MB work in their intended conduction states. This proper biasing is essential for the correct functioning of the preselector circuits, enabling controlled precharging sequences during startup and preventing voltage overshoots or excessive inrush currents that could damage the DC-DC power converter 5.

During the switching activity that begins at T5, the voltage VO3 becomes the positive rail of the floating voltage PCLAMP (and in general of the stage 60) because VP is shorted to Nn3 (VO3) through MB. Once the switching activity commences at T5 and transistor MB is turned on, the subsequent transition of VO3 to its steady-state value is governed by the converter's control loop operation, independent of the preselector core 50. The preselector core 50 primary function of managing voltage differences and ensuring safe operation during startup is complete at this stage, with the actual voltage regulation being handled by the converter's control mechanisms.

While the preselector-based DC-DC power converter 5 described above offers several advantages, it is important to note certain limitations in its current embodiment. A significant drawback lies in the bias point selection for the preselection voltage VP. This selection occurs at a single time instant and is not based on continuous monitoring of the actual analog values of the voltages VIN and VO3. A vulnerability exists in the case of a short circuit at voltage VO3 during switching activity, particularly after the ENMB signal has turned on transistor MB. In this scenario, there is no inherent current limitation from the voltage VIN to the short circuit. This absence of current limiting presents a high risk of damage to the internal circuitry, potentially compromising the reliability and longevity of the device.

These limitations highlight areas for potential improvement in future iterations of the design, particularly in implementing more robust voltage monitoring and protection mechanisms. As such, further development is necessary.

### SUMMARY

A DC-DC power converter includes a first inductor having a first terminal coupled to an input voltage and a second terminal. The converter has a first capacitor having a first terminal and a second terminal coupled to ground, with the first terminal generating an output voltage. A continuous-time comparator has a first input coupled to the input voltage and a second input coupled to the output voltage, where the continuous-time comparator generates a comparison signal based on a voltage differential between the input voltage and the output voltage. A preselector management circuit is coupled to receive the comparison signal. A preselector core is coupled between the first terminal of the first inductor and the first terminal of the first capacitor.

The preselector management circuit may be configured to generate multiple bias voltages. The preselector core may include a first p-channel transistor having a source coupled to a first node, a drain coupled to the first terminal of the first inductor, and a gate coupled to receive a first bias voltage. A second p-channel transistor may have a source coupled to the first node, a drain coupled to the first terminal of the capacitor, and a gate coupled to receive a second bias voltage. A third p-channel transistor may have a source coupled to the first node, a drain coupled to the first terminal of the first inductor, and a gate coupled to the first terminal of the capacitor.

The preselector management circuit may include a first inverter chain powered between a preselection voltage and a voltage called LOGIC, where the first inverter chain generates the first bias voltage. A second inverter may be powered between the preselection voltage and a clamp voltage, where the second inverter generates the second bias voltage. A voltage clamp circuit may generate the clamp voltage based on the comparison signal.

The voltage clamp circuit may include a resistor coupled between the preselection voltage and a third node. A Zener diode may have a cathode coupled to the preselection voltage and an anode coupled to the third node. A switching circuit may be coupled between the third node and ground, where the switching circuit is controlled by the comparison signal.

The switching circuit may include a first p-channel transistor having a source coupled to the third node, a gate coupled to receive the comparison signal, and a drain coupled to a fourth node. A third transistor may have a drain coupled to the fourth node, a source coupled to ground, and a gate coupled to a current mirror.

The continuous-time comparator may include a current mirror with first and second transistors, a first resistor coupled between the output voltage and the first transistor, a resistor network coupled to the second transistor, and a differential pair controlled by a voltage developed across the resistor network.

The continuous-time comparator may further include a first inverter having an input coupled to a first node and powered between the input voltage and ground. A second inverter may have an output coupled to the first node and be powered between the input voltage and ground. A third p-channel transistor may have a gate coupled to an output of the first inverter, a source coupled to a second node, and a drain coupled to a third node. The resistor network may include a first resistor coupled between the second node and the third node, a second resistor coupled between the third node and a fourth node, and a third resistor coupled between the fourth node and the second transistor of the current mirror. A fourth resistor may be coupled between the second node and the differential pair.

A high-side power and logic circuit may include an inverter powered between a preselection voltage and a clamp voltage, and switching transistor that may be a p-channel transistor having a gate coupled to an output of the inverter.

When the input voltage exceeds the output voltage, the continuous-time comparator generates the comparison signal to cause the preselector management circuit to disable a recirculation path through the preselector core; and a high-side command signal controls the switching transistor to charge the capacitor through a charging path.

A control circuit for a DC-DC power converter includes a continuous-time comparator having a first input coupled to receive an input voltage and a second input coupled to receive an output voltage. The continuous-time comparator generates a comparison signal based on a voltage differential between the input voltage and the output voltage. The control circuit has a preselector management circuit coupled to receive the comparison signal and configured to generate multiple bias voltages. A preselector core is configured to selectively enable a charging path and a recirculation path based on the bias voltages.

When the input voltage exceeds the output voltage, the comparison signal may cause the preselector management circuit to disable the recirculation path and enable the charging path in response to a high-side command signal. When the output voltage exceeds the input voltage, the comparison signal may cause the preselector management circuit to disable the charging path and enable the recirculation path.

The preselector management circuit may further include a first transistor having a first terminal coupled to receive the output voltage, a control terminal coupled to receive the clamp voltage, and a second terminal coupled to a first node. A second transistor may have a first terminal coupled to the first node, a control terminal coupled to receive the comparison signal, and a second terminal coupled to ground through a resistor. A logic voltage may be generated at the first node.

### BRIEF DESCRIPTION OF THE DRAWINGS

FIG. 1 is a schematic diagram of a prior art DC-DC power converter including a preselector core and preselector management circuit.

FIG. 1A is a schematic diagram of the prior art DC-DC power converter of FIG. 1, illustrating current paths during initial VO3 charging.

FIG. 1B is a schematic diagram of the prior art DC-DC power converter of FIG. 1, illustrating current paths during normal operation.

FIG. 2 is a timing diagram illustrating various voltage and control signals during operation of the prior art DC-DC power converter of FIG. 1.

FIG. 3 is a schematic diagram of a DC-DC power converter including a continuous-time comparator, preselector management circuit, and preselector core according to this disclosure.

FIG. 3A is a schematic diagram of the DC-DC power converter of FIG. 3, illustrating current paths when VIN exceeds VO3.

FIG. 3B is a schematic diagram of the DC-DC power converter of FIG. 3, illustrating current paths when VO3 exceeds VIN.

### DETAILED DESCRIPTION

The following disclosure enables a person skilled in the art to make and use the subject matter described herein. The general principles outlined in this disclosure can be applied to embodiments and applications other than those detailed above without departing from the spirit and scope of this disclosure. It is not intended to limit this disclosure to the embodiments shown, but to accord it the widest scope consistent with the principles and features disclosed or suggested herein.

Note that in the following description, any resistor or resistance mentioned is a discrete device, unless stated otherwise, and is not simply an electrical lead between two points. Therefore, any resistor or resistance connected between two points has a higher resistance than a lead between those two points, and such resistor or resistance cannot be interpreted as a lead. Similarly, any capacitor or capacitance mentioned is a discrete device, unless stated otherwise, and is not a parasitic element, unless stated otherwise. Additionally, any inductor or inductance mentioned is a discrete device, unless stated otherwise, and is not a parasitic element, unless stated otherwise.

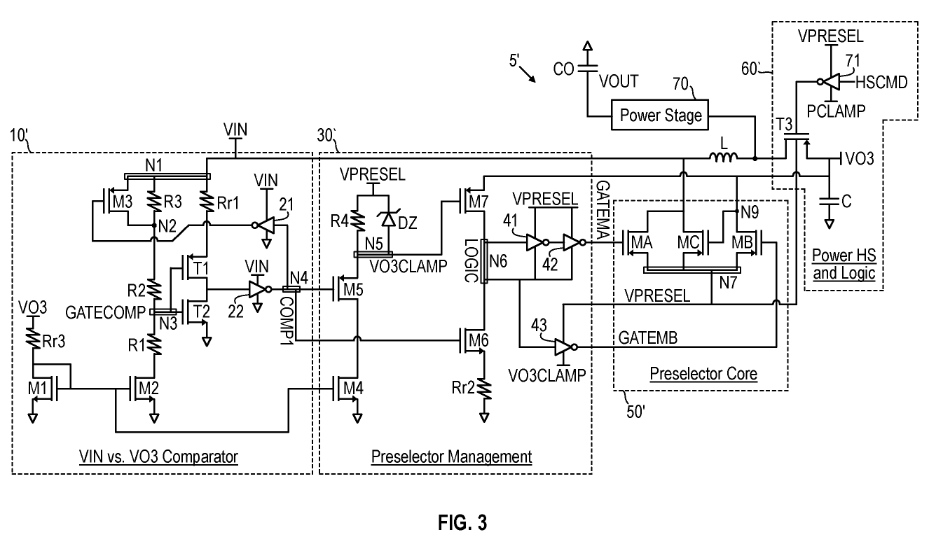

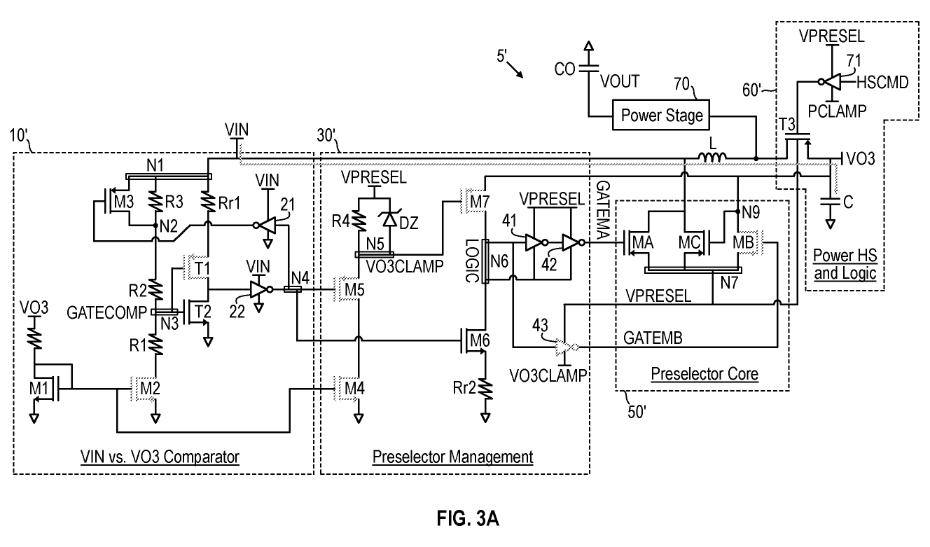

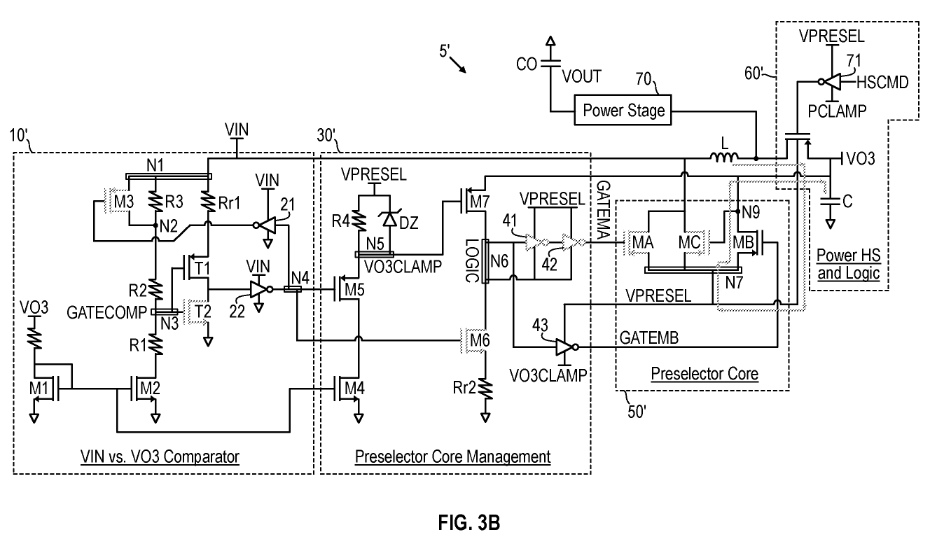

Refer now to FIG. 3, which illustrates a DC-DC converter 5' including a DC-DC converter circuit disclosed herein, including a continuous-time comparator 10' and preselector management circuit 30' for controlling a preselector core 50' and a high-side power and logic circuit 60'.

The high-side power and logic circuit 60' includes an inverter 71 powered between a preselection voltage VPRESEL and a clamp voltage PCLAMP (a floating rail whose positive voltage is the preselector voltage VPRESEL), the inverter 71 receiving a high-side command HSCMD signal at its input. A p-channel high-side power transistor T3 has its source connected to a first terminal of a capacitor C, with the second terminal of the capacitor C being coupled to ground. The p-channel transistor T3 has its gate connected to the output of the inverter 71 and its drain connected to a second terminal of an inductor L, the inductor L having its first terminal coupled to receive an input voltage VIN.

In the input voltage VIN versus output voltage VO3 comparator 10’, a resistor Rr3 has its first terminal coupled to the output voltage VO3 and its second terminal connected to the drain of n-channel transistor M1, which in turn has its source connected to ground and its gate connected to its drain. An n-channel transistor M2 has its gate connected to the gate and drain of n-channel transistor M1, its source connected to ground, and its drain connected to a second terminal of a resistor R1, the resistor R1 having its first terminal connected to node N3. A resistor R3 is connected between nodes N1 and N2. A resistor R2 is connected between nodes N2 and N3.

A resistor Rr1 is connected between node N1 and the source of p-channel transistor T1, with the drain of p-channel transistor T1 being connected to the drain of n-channel transistor T2, and the source of n-channel transistor T2 being coupled to ground. The gates of transistors T1 and T2 are connected to node N3, where the GATECOMP voltage is formed.

An inverter 22 is powered between the input voltage VIN and ground, with the input of the inverter 22 being connected to the drains of transistors T1 and T2 and the output of inverter 22 being connected to node N4. An inverter 21 is powered between the input voltage VIN and ground, with the input of the inverter 21 being connected to node N4 and the output of inverter 21 being connected to the gate of p-channel transistor M3, with p-channel transistor M3 having its source connected to node N1 and its drain connected to node N2.

Within the preselector management circuitry 30’, a resistor R4 is connected between the VPRESEL voltage and node N5, and a Zener diode DZ has its cathode connected to the voltage VPRESEL and its anode connected to node N5. P-channel transistor M5 has its source connected to node N5, its gate connected to node N4, and its drain connected to the drain of n-channel transistor M4, with n-channel transistor M4 having its source connected to ground and its gate connected to the gates of n-channel transistors M1 and M2. The voltage VO3CLAMP is formed at node N5. P-channel transistor M7 has its source connected to the first terminal of capacitor C, its drain connected to node N6, and its gate connected to node N5. N-channel transistor M6 has its drain connected to node N6, its source coupled to ground through resistor Rr2, and its gate connected to node N4, where the COMP1 voltage is produced.

An inverter 41 has its input connected to node N6 and its output connected to the input of inverter 42, which in turn has its output connected to the gate of p-channel transistor MA. Inverters 41 and 42 are powered between VPRESEL and the voltage at node N6, which is designated as the LOGIC voltage. An inverter 43 has its input connected to node N6 and its output connected to the gate of p-channel transistor MB, generating the GATEMB signal. Inverter 43 is powered between the VPRESEL and VO3CLAMP voltages.

Within the preselector core 50', p-channel transistor MA has its drain connected to the first terminal of inductor L, its source connected to node N7, and its gate connected to the output of inverter 42, which generates the gate control GATEMA signal for transistor MA. P-channel transistor MC has its drain connected to the first terminal of inductor L, its source connected to node N7, and its gate connected to node N9. P-channel transistor MB has its drain connected to node N9 (which is connected to the first terminal of capacitor C), its source connected to node N7, and its gate coupled to receive the gate control GATEMB signal from the output of the inverter 43.

The power stage 70 is connected between node Nn1 and ground.

When the input voltage VIN exceeds the output voltage VO3, the circuit establishes specific bias conditions through the following mechanism: First, in comparator 10’, a current in Rr3 is generated when VO3 exceeds the threshold voltage of M1. The magnitude of this current through Rr3 is directly proportional to and determined by the VO3 voltage value, with M1's threshold voltage serving as the activation point for current flow. This current is mirrored through transistor M2, but is insufficient to pull down node N3, resulting in GATECOMP being biased to VIN. Through inverters 21 and 22, this causes the voltage COMP1 at node N4 to also be biased to the input voltage VIN.

With the signal COMP1 at VIN, transistor M6 in the preselector management circuit 30' is turned on, while transistor M5 is held off. Consequently, the voltage VO3CLAMP remains at the level of the voltage VPRESEL through resistor R4. Meanwhile, with transistor M6 on and transistor M7 off (due to its gate being held at the voltage VO3CLAMP), the LOGIC node (N6) is pulled to ground through resistor Rr2.

These bias conditions cascade through the inverter chain. Inverters 41 and 42 operate between voltage VPRESEL and the grounded LOGIC node, resulting in gate control GATEMA signal being held at ground. Inverter 43, powered between voltage VPRESEL and voltage VO3CLAMP, has no effective supply voltage differential since both rails are at voltage VPRESEL, rendering it unable to actively drive transistor MB. This ensures transistor MB remains off while allowing the gate control GATEMB signal to float to voltage VPRESEL.

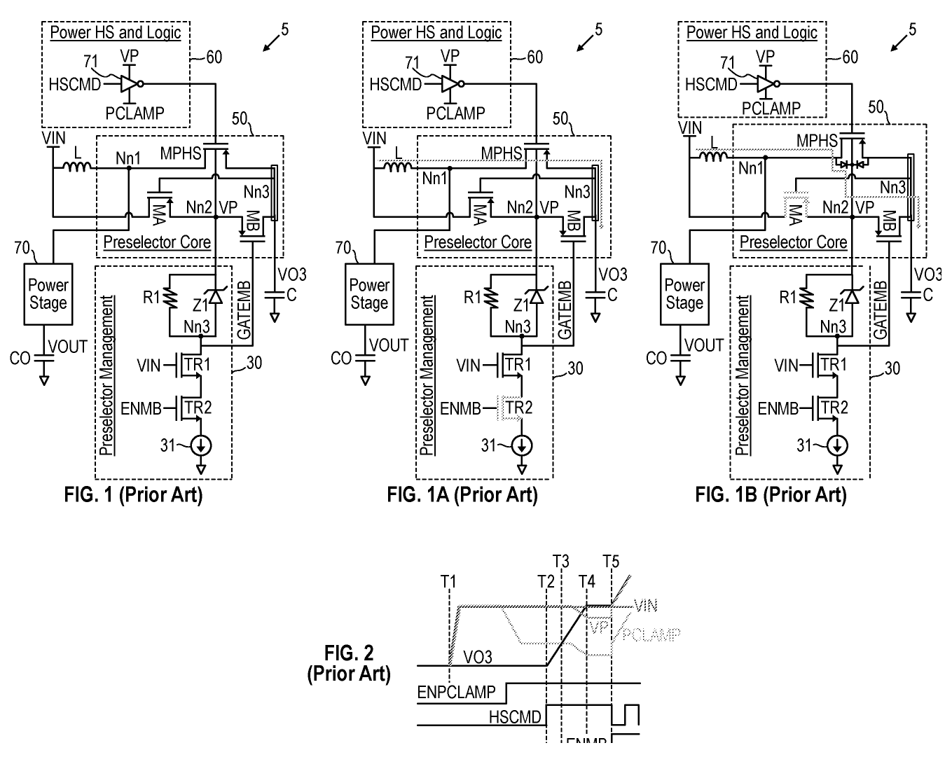

In this configuration, the precharging of voltage VO3 is accomplished through the HSCMD signal toggling. When the HSCMD signal toggles high, inverter 71 (powered between voltages VPRESEL and PCLAMP) drives the gate of transistor T3 low, turning it on. This creates a current path from input voltage VIN through inductor L and transistor T3 to charge capacitor C, gradually bringing the voltage VO3 toward the voltage VIN, as shown in FIG. 3A. The inherent resistance of transistor T3 and the inductor L naturally limit the charging current, protecting against excessive inrush current during this precharge phase. Unlike the prior art circuit of FIG. 1, there is no discrete logic controlling the bias point selection of the preselector. Instead, this function is performed through the continuous-time analog comparator 10', providing more responsive and adaptive control based on the actual voltage differential between voltages VIN and VO3. The comparator 10' itself does not generate the HSCMD signal, but rather establishes the proper bias conditions that enable safe precharging of VO3 during startup. The HSCMD signal is independently temporized as part of the startup procedure, with the comparator's bias conditions ensuring that when HSCMD toggles, the precharge occurs safely without risk of excessive current flow.

When the output voltage VO3 exceeds the input voltage VIN, the circuit establishes a different set of bias conditions through the following mechanism. First, in comparator 10', the voltage differential causes sufficient current through resistor Rr3 and transistor M1 such that the mirrored current through transistor M2 can effectively pull down node N3, resulting in the GATECOMP voltage at node N3 being biased to ground. Through inverters 21 and 22, this causes the voltage COMP1 at node N4 to also be biased to ground.

With the voltage COMP1 at ground, transistor M6 in the preselector management circuit 30' is turned off, while transistor M5 turns on. Combined with the action of Zener diode DZ, this establishes the voltage VO3CLAMP close to ground until VPRESEL is lower than the activation threshold of the Zener DZ. The voltage LOGIC is pulled-up because M6 is turned off, since the net COMP1 is at ground and the voltage VO3_CLAMP is close to ground, enabling M7.

These bias conditions create a different inverter chain response than when the input voltage VIN exceeds the voltage VO3. Inverter 41 and inverter 42 do not have a rail because LOGIC net is pulled up to VO3 by M7 (considering the boundary condition where VO3 is slightly over VIN). In this way GATEMA is at VPRESEL, turning-off MA. Inverter 43, now properly powered between voltages VPRESEL and VO3CLAMP, can actively drive transistor MB through the signal GATEMB.

In this operating state, transistor MB turns on, creating a direct path between voltages VPRESEL and VO3. The current recirculation path is established from the input voltage VIN through the drain-body diode of transistor T3, then through transistor MB's source-drain path, ultimately connecting to capacitor C, as shown in FIG. 3B. In this configuration, transistor MB effectively operates as a switch managing the current path.

To complete the DC-DC converter 5' and achieve full voltage conversion functionality, a power stage 70 is integrated into the system. The power stage 70 connects between node N1, which is already connected to the second terminal of inductor L and ground.

The voltage VO3 is the output of the boost converter and it is generated at the first terminal of capacitor C. It also works as an internal supply voltage and influences the biasing of transistors within the preselector core 50' and the preselector management circuit 30'. Specifically, VO3 affects the biasing of transistors like T1, T2, M1, M2, and M4 in the comparator 10', which in turn determine the conduction states of transistors in the preselector core and management circuits. By providing this internal voltage, VO3 ensures that gate-source voltages of key transistors are properly biased, allowing them to operate correctly and preventing uncontrolled current paths during startup or when voltage differentials occur.

When the input voltage VIN exceeds the output voltage VO3, the comparator 10' detects this condition and establishes specific bias conditions for a smooth recharge of VO3 during start-up. This gradual charging prevents excessive inrush currents and allows VO3 to safely approach VIN. Conversely, when VO3 exceeds VIN, the comparator adjusts the biasing to prevent reverse current flow and manage the current recirculation path effectively.

The DC-DC power converter 5' described herein provides several significant advantages over the prior art. One advantage lies in its use of the comparator 10’ architecture that performs real-time comparison of the actual values of the voltages VIN and VO3. This approach eliminates the static current consumption typically present during reset phases in conventional designs.

Furthermore, the continuous-time nature of the VIN-versus-VO3 comparison provides substantial benefits over discrete-time or logic-controlled solutions. By continuously monitoring these voltages through analog comparator 10', the circuit can respond immediately to voltage differentials without requiring complex timing or control logic. This continuous monitoring capability eliminates the need for dedicated logic circuitry to manage the preselector core 50', resulting in a simpler, more efficient architecture.

The direct analog comparison approach, combined with the automated bias point selection, enables more responsive and reliable operation while reducing circuit complexity and power consumption. These advantages make the described DC-DC power converter 5' particularly well-suited for applications requiring efficient voltage conversion with minimal control overhead.

Finally, it is evident that modifications and variations can be made to what has been described and illustrated herein without departing from the scope of this disclosure.

Although this disclosure has been described with a limited number of embodiments, those skilled in the art, having the benefit of this disclosure, can envision other embodiments that do not deviate from the disclosed scope. Furthermore, skilled persons can envision embodiments that represent various combinations of the embodiments disclosed herein made in various ways.

1. A DC-DC power converter, comprising:
an inductor having: a first terminal coupled to an input voltage, and a second terminal;
a capacitor having: a first terminal, and a second terminal coupled to ground, the first terminal generating an output voltage;
a continuous-time comparator: having a first input coupled to the input voltage, and a second input coupled to the output voltage, the continuous-time comparator generating a comparison signal based on a voltage differential between the input voltage and the output voltage;
a preselector management circuit coupled to receive the comparison signal; and
a preselector core coupled between the first terminal of the inductor and the first terminal of the capacitor.

2. The DC-DC power converter of claim 1,
wherein the preselector management circuit is configured to generate a plurality of bias voltages;
wherein the preselector core comprises:
a first p-channel transistor (MA) having: a source coupled to a first node, a drain coupled to the first terminal of the inductor, and a gate coupled to receive a first bias voltage of the plurality of bias voltages;
a second p-channel transistor (MB) having a source coupled to the first node, a drain coupled to the first terminal of the capacitor and a gate coupled to receive a second bias voltage of the plurality of bias voltages; and
a third p-channel transistor (MC) having: a source coupled to the first node, a drain coupled to the first terminal of the inductor, and a gate coupled to the first terminal of the capacitor.

3. The DC-DC power converter of claim 2, wherein the preselector management circuit comprises:
a first inverter chain powered between a preselection voltage and a logic voltage, the first inverter chain generating the first bias voltage;
a second inverter powered between the preselection voltage and a clamp voltage, the second inverter generating the second bias voltage; and
a voltage clamp circuit generating the clamp voltage based on the comparison signal.

4. The DC-DC power converter of claim 3, wherein the voltage clamp circuit comprises:
a resistor coupled between the preselection voltage and a third node;
a Zener diode having a cathode coupled to the preselection voltage and an anode coupled to the third node; and
a switching circuit coupled between the third node and ground, the switching circuit controlled by the comparison signal.

5. The DC-DC power converter of claim 4, wherein the switching circuit comprises:
a first p-channel transistor having: a source coupled to the third node, a gate coupled to receive the comparison signal, and a drain coupled to a fourth node; and
a third transistor having: a drain coupled to the fourth node, a source coupled to ground, and a gate coupled to a current mirror.

6. The DC-DC power converter of claim 3, wherein the preselector management circuit further comprises:
a first p-channel transistor (M7) having: a source coupled to the first terminal of the capacitor, a gate coupled to receive the clamp voltage, and a drain coupled to a fourth node; and
a first n-channel transistor (M6) having: a drain coupled to the fourth node, a gate coupled to receive the comparison signal, and a source coupled to ground through a resistor;
wherein a logic voltage is generated at the fourth node .

7. The DC-DC power converter of claim 3, wherein the preselector management circuit further comprises:
a first p-channel transistor (7) having: a source coupled to the first terminal of the capacitor, a gate coupled to receive the clamp voltage, and a drain coupled to a fourth node; and
a first n-channel transistor (M6) having: a drain coupled to the fourth node, a gate coupled to receive the comparison signal, and a source coupled to ground through a resistor;
wherein the logic voltage is generated at the fourth node;
wherein the first and second inverters comprise a first inverter chain powered between the preselection voltage and the logic voltage, the first inverter chain generating the first bias voltage; and
wherein the second inverter comprises a third inverter powered between the preselection voltage and the clamp voltage.

8. The DC-DC power converter of claim 1, wherein the continuous-time comparator comprises:
a current mirror including first and second transistors;
a first resistor coupled between the output voltage and the first transistor;
a resistor network coupled to the second transistor; and
a differential pair controlled by a voltage developed across the resistor network.

9. The DC-DC power converter of claim 8, wherein the continuous-time comparator further comprises:
a first inverter having an input coupled to a first node and powered between the input voltage and ground;
a second inverter having an output coupled to the first node and powered between the input voltage and ground; and
a third p-channel transistor having: a gate coupled to an output of the first inverter, a source coupled to a second node, and a drain coupled to a third node;
wherein the resistor network comprises:
a first resistor coupled between the second node and the third node;
a second resistor coupled between the third node and a fourth node; and
a third resistor coupled between the fourth node and the second transistor of the current mirror;
wherein a fourth resistor is coupled between the second node and the differential pair.

10. The DC-DC power converter of claim 1, further comprising: a high-side power and logic circuit including: an inverter powered between a preselection voltage and a clamp voltage; and a switching transistor comprising a p-channel transistor having a gate coupled to an output of the inverter.

11. The DC-DC power converter of claim 10, wherein: when the input voltage exceeds the output voltage: the continuous-time comparator generates the comparison signal to cause the preselector management circuit to disable a recirculation path through the preselector core; and a high-side command signal controls the switching transistor to charge the capacitor through a charging path.

12. A control circuit for a DC-DC power converter, comprising:
a continuous-time comparator having a first input coupled to receive an input voltage and a second input coupled to receive an output voltage, the continuous-time comparator generating a comparison signal based on a voltage differential between the input voltage and the output voltage;
a preselector management circuit coupled to receive the comparison signal and configured to generate a plurality of bias voltages; and
a preselector core configured to selectively enable a charging path and a recirculation path based on the plurality of bias voltages.

13. The control circuit of claim 12, wherein the preselector management circuit comprises:
a first inverter chain powered between a preselection voltage and a logic voltage, the first inverter chain generating a first bias voltage of the plurality of bias voltages;
a second inverter powered between the preselection voltage and a clamp voltage, the second inverter generating a second bias voltage of the plurality of bias voltages; and
a voltage clamp circuit generating the clamp voltage based on the comparison signal.

14. The control circuit of claim 13, wherein the voltage clamp circuit comprises:
a resistor coupled between the preselection voltage and a first node;
a Zener diode having a cathode coupled to the preselection voltage and an anode coupled to the first node; and
a switching circuit coupled between the first node and ground, the switching circuit controlled by the comparison signal.

15. The control circuit of claim 12, wherein the continuous-time comparator comprises:
a current mirror including first and second transistors;
a first resistor coupled between the output voltage and the first transistor;
a resistor network coupled to the second transistor; and
an inverter with a degeneration controlled by a voltage developed across the resistor network.

16. The control circuit of claim 15, wherein the continuous-time comparator further comprises:
a first inverter powered between the input voltage and ground;
a second inverter powered between the input voltage and ground; and
a third transistor having a control terminal coupled to an output of the first inverter;
wherein the resistor network comprises: a first resistor coupled between a second node and a third node; a second resistor coupled between the third node and a fourth node; and a third resistor coupled between the fourth node and the second transistor of the current mirror.

17. The control circuit of claim 12, wherein when the input voltage exceeds the output voltage, the comparison signal causes the preselector management circuit to: disable the recirculation path; and enable the charging path in response to a high-side command signal.

18. The control circuit of claim 12, wherein when the output voltage exceeds the input voltage, the comparison signal causes the preselector management circuit to: disable the charging path; and wherein the recirculation path is enabled in response to a high-side command signal.

19. The control circuit of claim 12, wherein the preselector management circuit further comprises:
a first transistor having a first terminal coupled to receive the output voltage, a control terminal coupled to receive the clamp voltage, and a second terminal coupled to a first node; and
a second transistor having a first terminal coupled to the first node, a control terminal coupled to receive the comparison signal, and a second terminal coupled to ground through a resistor; wherein the logic voltage is generated at the first node.
